(19) United States
(12) Patent Application Publication
(10) Pub. No.: US 2025/0293409 A1
(43) Pub. Date: Sep. 18, 2025

(54) ELECTRICITY STORAGE CELL

(71) Applicant: TOYOTA JIDOSHA KABUSHIKI KAISHA, Toyota-shi (JP)

(72) Inventors: Masato ONO, Nagoya-shi (JP); Masahiro Ishizuka, Toyota-shi (JP); Atsushi Sugihara, Toyota-shi (JP); Yuka Yokoi, Nagoya-shi (JP); Keitaro Machida, Hamamatsu-shi (JP); Ryosuke Sato, Toyota-shi (JP); Tatsuya Yamamoto, Toyohashi-shi (JP)

(73) Assignee: TOYOTA JIDOSHA KABUSHIKI KAISHA, Toyota-shi (JP)

(21) Appl. No.: 18/987,926

(22) Filed: Dec. 19, 2024

(30) Foreign Application Priority Data
Mar. 18, 2024 (JP) 2024-042040

(51) Int. Cl. H01M 50/538; H01M 10/04; H01M 50/105

(52) U.S. Cl. CPC H01M 50/538; H01M 10/0431; H01M 50/105

(57) ABSTRACT

An electricity storage cell includes a pair of electrode assemblies each configured of a wound assembly. Each electrode assembly includes a coated portion, an uncoated portion, and a current collecting tab. The uncoated portion includes an outer end surface, an inner end surface, and a coupling surface. The current collecting tab protrudes from at least one of the inner end surface and the coupling surface. The outer end surface of one electrode assembly faces the inner end surface of the other electrode assembly. The inner end surface of the one electrode assembly faces the outer end surface of the other electrode assembly. The coupling surface of the one electrode assembly faces the coupling surface of the other electrode assembly in a direction intersecting with an axial direction. The current collecting tab of the one electrode assembly is connected to the current collecting tab of the other electrode assembly.

### CROSS-REFERENCE TO RELATED APPLICATION

This application claims priority to Japanese Patent Application No. 2024-042040 filed on Mar. 18, 2024. The disclosure of the above-identified application, including the specification, drawings, and claims, is incorporated by reference herein in its entirety.

### BACKGROUND

### 1. Technical Field

The present disclosure relates to an electricity storage cell.

### 2. Description of Related Art

For example, Japanese Unexamined Patent Application Publication No. 2016-207516 (JP 2016-207516 A) discloses a battery including a wound electrode assembly, a battery case that accommodates the wound electrode assembly, and an electrode terminal connected to a current collecting tab of the wound electrode assembly. The current collecting tab protrudes upward from a power generating region.

### SUMMARY

The electricity storage cell as described in JP 2016-207516 A preferably has a high energy density.

The present disclosure has an object to provide an electricity storage cell with which an energy density can be improved.

An electricity storage cell according to one aspect of the present disclosure includes: a pair of electrode assemblies each configured of a wound assembly, each of the electrode assemblies including: a coated portion including a current collecting foil and an active material layer provided on the current collecting foil; an uncoated portion that protrudes from the coated portion in an axial direction of the coated portion, the uncoated portion being configured only of the current collecting foil; and a current collecting tab that protrudes from the uncoated portion. The uncoated portion includes: an outer end surface provided on an outer side in the axial direction; an inner end surface provided on an inner side from the outer end surface in the axial direction; and a coupling surface that couples the outer end surface and the inner end surface. The current collecting tab protrudes from at least one of the inner end surface and the coupling surface. The outer end surface of one of the electrode assemblies faces the inner end surface of the other one of the electrode assemblies. The inner end surface of the one of the electrode assemblies faces the outer end surface of the other one of the electrode assemblies. The coupling surface of the one of the electrode assemblies faces the coupling surface of the other one of the electrode assemblies in a direction intersecting with the axial direction. The current collecting tab of the one of the electrode assemblies is connected to the current collecting tab of the other one of the electrode assemblies.

According to the present disclosure, it is possible to provide the electricity storage cell with which the energy density can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating an electricity storage cell according to an embodiment of the present disclosure;

FIG. 2 is a front view of a cell unit;

FIG. 3 is a front view of an electrode assembly;

FIG. 4 is a perspective view of the electrode assembly; and

FIG. 5 is a perspective view illustrating a modification example of the electrode assembly.

### DETAILED DESCRIPTION OF EMBODIMENTS

An embodiment of the present disclosure is described with reference to the drawings. It is to be noted that, in the drawings referred to below, the same or corresponding members are denoted by the same reference symbols.

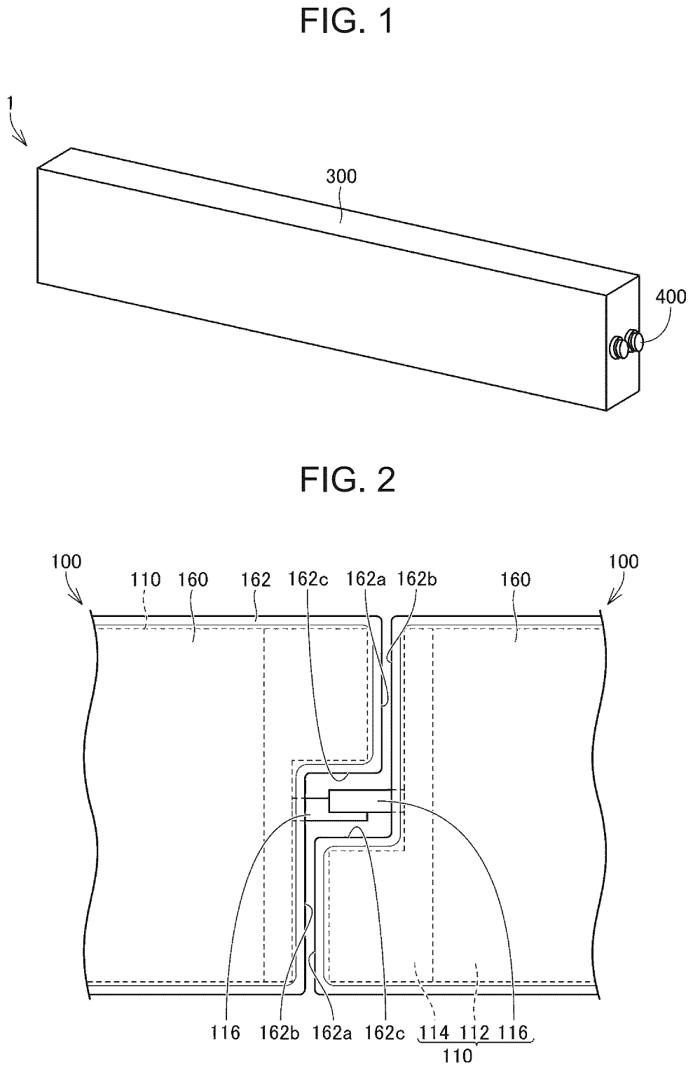

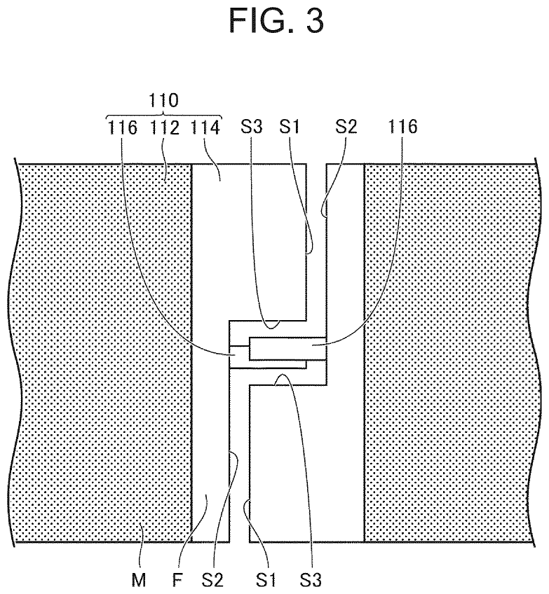

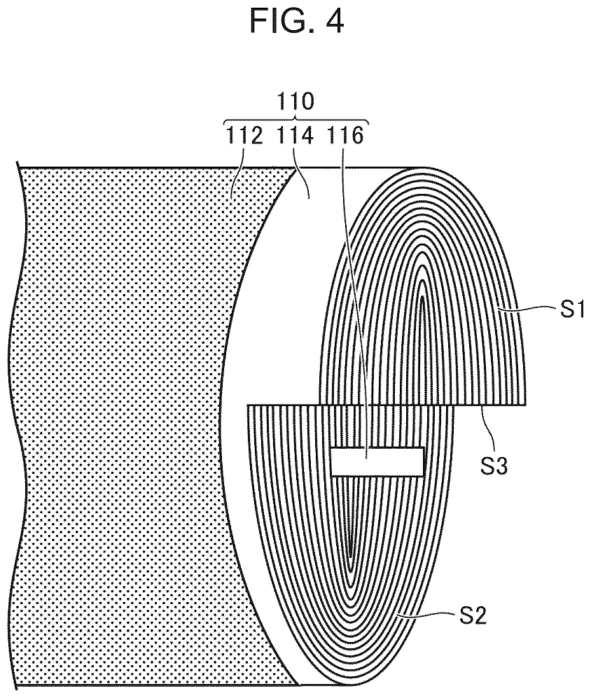

FIG. 1 is a perspective view schematically illustrating an electricity storage cell according to an embodiment of the present disclosure. FIG. 2 is a front view of a cell unit. FIG. 3 is a front view of an electrode assembly. FIG. 4 is a perspective view of the electrode assembly. An electricity storage cell 1 is to be mounted on, for example, a bottom portion of a vehicle.

As illustrated in FIG. 1 to FIG. 4, the electricity storage cell 1 includes a plurality of cell units 100, a cell case 300, and an external terminal 400.

The cell units 100 include at least a pair of cell units 100. Each cell unit 100 includes an electrode assembly 110 and a laminate outer casing 160.

The electrode assembly 110 is configured of a wound assembly obtained by winding a positive electrode sheet and a negative electrode sheet through intermediation of a separator. The electrode assembly 110 is formed in a shape that is long in an axial direction of the wound assembly (right-left direction in FIG. 3). The electrode assembly 110 includes a coated portion 112, an uncoated portion 114, and a current collecting tab 116.

The coated portion 112 includes a current collecting foil F (see FIG. 3) and an active material layer M (see FIG. 3) provided on the current collecting foil F. The current collecting foil F is made of a metal foil. The active material layer M is provided on the surface of the current collecting foil F. It is to be noted that, in FIG. 3 and FIG. 4, the coated portion 112 is illustrated in a dot pattern.

The uncoated portion 114 protrudes from the coated portion 112 in the axial direction. The uncoated portion 114 is configured only of the current collecting foil F. The uncoated portion 114 includes an outer end surface S1, an inner end surface S2, and a coupling surface S3.

The outer end surface S1 is provided on the outer side in the axial direction. The outer end surface S1 is formed substantially flat.

The inner end surface S2 is provided on the inner side from the outer end surface S1 in the axial direction. The inner end surface S2 is formed substantially flat.

The coupling surface S3 couples the outer end surface S1 and the inner end surface S2. The coupling surface S3 is provided along the axial direction. In this embodiment, the coupling surface S3 is parallel to the axial direction.

As illustrated in FIG. 3, the outer end surface S1 of one of the electrode assemblies 110 faces the inner end surface S2 of the other one of the electrode assemblies 110. The inner end surface S2 of the one of the electrode assemblies 110 faces the outer end surface S1 of the other one of the electrode assemblies 110. The coupling surface S3 of the one of the electrode assemblies 110 faces the coupling surface S3 of the other one of the electrode assemblies 110 in the direction intersecting with the axial direction.

The current collecting tab 116 protrudes from the uncoated portion 114. In this embodiment, the current collecting tab 116 protrudes from the inner end surface S2. The current collecting tab 116 is configured of the current collecting foil F. The current collecting tab 116 is integrally connected to the current collecting foil F configuring the uncoated portion 114. As illustrated in FIG. 2 and FIG. 3, the current collecting tab 116 of the one of the electrode assemblies 110 is connected to the current collecting tab 116 of the other one of the electrode assemblies 110.

The laminate outer casing 160 accommodates the electrode assembly 110. The laminate outer casing 160 is made of a laminated film. As illustrated FIG. 2, the laminate outer casing 160 includes an edge portion 162. The edge portion 162 is formed by connecting (welding) laminated films to each other. The current collecting tab 116 protrudes from the edge portion 162 of the laminate outer casing 160.

The laminate outer casing 160 includes an outer covering portion 162a, an inner covering portion 162b, and a coupling covering portion 162c. The outer covering portion 162a faces the outer end surface S1. The inner covering portion 162b faces the inner end surface S2. The coupling covering portion 162c faces the coupling surface S3. The current collecting tab 116 protrudes from the inner covering portion 162b.

The cell case 300 accommodates the cell units 100. The cell case 300 is made of, for example, aluminum. The cell case 300 is formed in a cuboid shape. As illustrated in FIG. 1, the cell case 300 includes a case main body 310 and a lid 320.

The case main body 310 is formed in a quadrangular tubular shape. The case main body 310 surrounds the cell units 100. The cell units 100 may be covered with a covering sheet (not shown) made of an insulating material (such as a synthetic resin), and the case main body 310 may surround the cell units 100 and the covering sheet.

The lid 320 is connected to the case main body 310 by welding or the like so as to close an opening of the case main body 310. The lid 320 includes a pair of the external terminals 400.

As described above, in the electricity storage cell 1 according to this embodiment, the coupling surfaces S3 of the electrode assemblies 110 face each other in the intersecting direction intersecting with the axial direction. In other words, a part of the uncoated portion 114 of one electrode assembly 110 overlaps a part of the uncoated portion 114 of the other electrode assembly 110 in the intersecting direction. Accordingly, as compared to a case in which the outer end surfaces of the uncoated portions 114 face each other in the axial direction without an overlap between the uncoated portions 114 of the respective electrode assemblies 110 in the intersecting direction, the dimension of each electrode assembly 110 in the axial direction is shortened. Thus, the size of each electrode 15 assembly 110 can be increased by this amount, that is, the energy density can be improved.

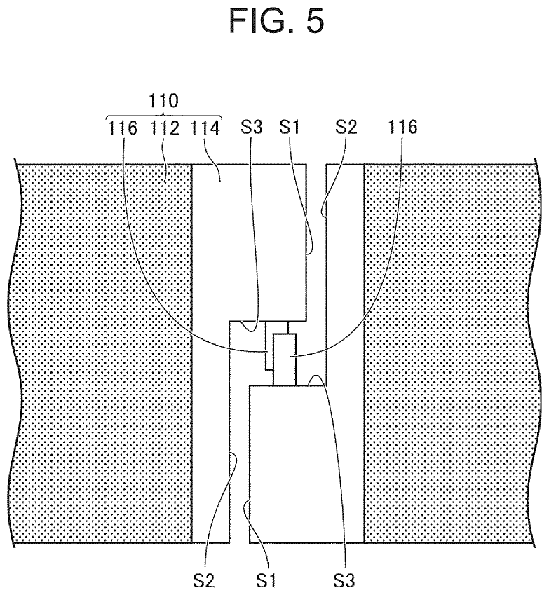

It is to be noted that, as illustrated in FIG. 5, the current collecting tab 116 may protrude from the coupling surface S3 in the intersecting direction.

The above-mentioned exemplary embodiment is understood as a specific example of the following aspects by a person skilled in the art.

Aspect 1

An electricity storage cell including a pair of electrode assemblies each configured of a wound assembly, each of the electrode assemblies including:
a coated portion including a current collecting foil and an active material layer provided on the current collecting foil;
an uncoated portion that protrudes from the coated portion in an axial direction of the coated portion, the uncoated portion being configured only of the current collecting foil; and
a current collecting tab that protrudes from the uncoated portion, in which
the uncoated portion includes:
an outer end surface provided on an outer side in the axial direction;
an inner end surface provided on an inner side from the outer end surface in the axial direction; and
a coupling surface that couples the outer end surface and the inner end surface,
the current collecting tab protrudes from at least one of the inner end surface and the coupling surface,
the outer end surface of one of the electrode assemblies faces the inner end surface of the other one of the electrode assemblies,
the inner end surface of the one of the electrode assemblies faces the outer end surface of the other one of the electrode assemblies,
the coupling surface of the one of the electrode assemblies faces the coupling surface of the other one of the electrode assemblies in a direction intersecting with the axial direction, and
the current collecting tab of the one of the electrode assemblies is connected to the current collecting tab of the other one of the electrode assemblies.

In the electricity storage cell, the coupling surfaces of the electrode assemblies face each other in the direction intersecting with the axial direction, and hence, as compared to the case in which the outer end surfaces of the electrode assemblies face each other in the axial direction, the dimension of each electrode assembly in the axial direction is shortened. Thus, the size of each electrode assembly can be increased by this amount, that is, the energy density can be improved.

Aspect 2

The electricity storage cell according to Aspect 1, further including a laminate outer casing that accommodates each of the electrode assemblies, in which the laminate outer casing includes:
an outer covering portion that faces the outer end surface;
an inner covering portion that faces the inner end surface; and
a coupling covering portion that faces the coupling surface.

It is to be noted that the embodiment disclosed herein is illustrative in all respects and is not restrictive. The scope of the disclosure is defined not by the description of the above embodiment but by the appended claims. The scope of the disclosure is intended to encompass all modifications within the scope of the appended claims and equivalents thereof.

What is claimed is:

1. An electricity storage cell comprising a pair of electrode assemblies each configured of a wound assembly, each of the electrode assemblies including:
a coated portion including a current collecting foil and an active material layer provided on the current collecting foil;
an uncoated portion that protrudes from the coated portion in an axial direction of the coated portion, the uncoated portion being configured only of the current collecting foil; and
a current collecting tab that protrudes from the uncoated portion, wherein the uncoated portion includes:
an outer end surface provided on an outer side in the axial direction;
an inner end surface provided on an inner side from the outer end surface in the axial direction; and
a coupling surface that couples the outer end surface and the inner end surface,
the current collecting tab protrudes from at least one of the inner end surface and the coupling surface,
the outer end surface of one of the electrode assemblies faces the inner end surface of the other one of the electrode assemblies,
the inner end surface of the one of the electrode assemblies faces the outer end surface of the other one of the electrode assemblies,
the coupling surface of the one of the electrode assemblies faces the coupling surface of the other one of the electrode assemblies in a direction intersecting with the axial direction, and
the current collecting tab of the one of the electrode assemblies is connected to the current collecting tab of the other one of the electrode assemblies.

2. The electricity storage cell according to claim 1, further comprising a laminate outer casing that accommodates each of the electrode assemblies, wherein the laminate outer casing includes:
an outer covering portion that faces the outer end surface;
an inner covering portion that faces the inner end surface; and
a coupling covering portion that faces the coupling surface.
